(19) United States
(12) Patent Application Publication
(10) Pub. No.: US 2025/0045108 A1
(43) Pub. Date: Feb. 6, 2025

(54) VEHICLE WORKLOAD OFFBOARDING

(71) Applicant: Ford Global Technologies, LLC, Dearborn, MI (US)

(72) Inventors: Kexun Chen, Canton, MI (US); Abdullah Ali Husain, Dearborn, MI (US)

(73) Assignee: Ford Global Technologies, LLC, Dearborn, MI (US)

(21) Appl. No.: 18/361,944

(22) Filed: Jul. 31, 2023

(51) Int. Cl. G06F 9/50

(52) U.S. Cl. CPC G06F 9/5027

(57) ABSTRACT

Systems and methods performed on a vehicle include: determining selected Internet of Things (IoT) devices from a plurality of IoT devices separate from the vehicle, wherein the selected IoT devices are selected based on being capable of performing a task including compute and/or storage for a vehicle subsystem; decomposing the task into a plurality of workloads to offboard for processing on respective selected IoT devices; and sending the workloads to the respective selected IoT devices.

### BACKGROUND

A vehicle may include one or more computing devices and memory for performing various computing and storage operations for the vehicle. Computing devices in a vehicle, e.g., electronic control units (ECUs) and the like, may communicate with each other via one or more vehicle networks, and/or may communicate with computing devices outside of a vehicle via one or more networks and/or communication protocols.

### BRIEF DESCRIPTION OF THE DRAWINGS

FIG. 1 is diagram of an example system for providing vehicle workload offboarding.

FIG. 2 is an example diagram of an offboard workload manager for a vehicle.

FIG. 3 is an example flow diagram of an offboard workload manager for a vehicle.

FIG. 4 an example operations diagram of an offboard workload management.

FIG. 5 is an example operations diagram of a backup master mechanism.

FIG. 6 is an example flow diagram for evaluating and selecting Internet of Things (IoT) devices for offboarding a task.

FIG. 7 is an example flow diagram of offboarding a vehicle task to IoT devices.

### DETAILED DESCRIPTION

A vehicle may include computing and/or storage devices for performing various computational or computing tasks (“compute tasks”) and/or storage tasks for the vehicle, but may need to prioritize these computing and/or storage resources as additional tasks are desired based upon the limited compute and storage resources of the vehicle. Internet of Things (IoT) devices may also include numerous computing and storage devices for performing compute and storage operations, and may designate a portion of these computing and/or storage resources as shared resources. In accordance with the present disclosure, various offboardable compute and/or storage tasks of a vehicle, such as those that may be performed asynchronously, may be offboarded from the vehicle to be performed using the shared resources of nearby IoT devices. Upon determining that such a task is suitable for being offboarded from the vehicle, the task may be split into a plurality of containers and sent to suitable IoT devices for performing the compute and/or storage operations of the task, and returned results data may be aggregated at the vehicle to complete the task.

Various tasks and types of tasks may be suitable for being offboarded in accordance with this disclosure. For example, a task for training a machine learning model used by the vehicle's intelligent cruise control may be offboarded since it does not need to be performed in real-time. Data collected from the intelligent cruise control system for training the machine learning model may be sent to IoT devices, such as to a user's mobile device and to a controller of a nearby traffic light, for performing training calculations on the data. The results data can be collected at the vehicle from the IoT devices, aggregated, and used to refine the machine learning model in the vehicle.

In another example, a task of storing a large amount of video data for later analysis may include the video data being split and offboarded to a storage of a nearby traffic camera and another vehicle having excess storage capacity. The stored video data can then be asynchronously uploaded to a central computer (e.g., the cloud) and a notification of completion of the task sent back to the vehicle. Alternatively, storage location data can be returned to the vehicle so that the stored data may be accessed later for analysis based on the storage location data, such as by a central computer or the vehicle.

In further examples and use cases, the workloads could be offboarded to conserve vehicle power. This could apply to an electric vehicle (EV), an internal combustion engine (ICE) vehicle, or a hybrid vehicle. In one usage case, the vehicle may offboard computations which are consuming significant resources and/or time to process, and then turn off. In another use case, workloads could be offboarded to move with a user.

In one or more implementation of the present disclosure, a system may include a vehicle computer of a vehicle having a processor and a memory. The memory may store instructions executable by the processor such that the computer is programmed to: determine selected Internet of Things (IoT) devices from a plurality of IoT devices separate from the vehicle, wherein the selected IoT devices are selected based on being capable of performing a task including compute and/or storage for a vehicle subsystem; decompose the task into a plurality of workloads to offboard for processing on respective selected IoT devices; and send the workloads to the respective selected IoT devices.

Another implementation may further include instructions to determine that the task is offboardable based on the task being permitted to use asynchronous processing.

In a further implementation, the instructions to determine the selected IoT devices may include instructions to evaluate available shared resources of IoT devices within a threshold distance relative to the vehicle.

In an implementation, the instructions to determine the selected IoT devices may include instructions to evaluate qualities of service (QOS) of the plurality of IoT devices.

In another implementation, the instructions to evaluate the QoS of the plurality of IoT devices may include instructions to filter the plurality of IoT devices based upon network connection parameters of the plurality of IoT devices.

In a further implementation, the instructions to evaluate the QoS of the plurality of IoT devices may include instructions to filter the plurality of IoT devices based upon an encryption compatibility of the plurality of IoT devices.

In another implementation, the instructions to evaluate the QoS of the plurality of IoT devices may include instructions to order the plurality of IoT devices based upon a best fit of available shared resources for the task and select a top number of the plurality of IoT devices as the selected IoT devices for offboarding of the task.

An implementation of the system may further include instructions to encode the plurality of workloads into a plurality of respective containers, each container including code and dependencies for one of the workloads of the decomposed task.

In another implementation, the instructions to send the workloads to the respective selected IoT devices may include instructions to transmit each of the plurality of containers to a respective one of the selected IoT devices.

Another implementation of the system may include instructions to receive and aggregate results data from the selected IoT devices for the workloads of the task to complete processing of the task.

In one or more implementation of the present disclosure, a method performed onboard a vehicle may include: determining selected Internet of Things (IoT) devices from a plurality of IoT devices separate from the vehicle, wherein the selected IoT devices are selected based on being capable of performing a task including compute and/or storage for a vehicle subsystem; decomposing the task into a plurality of workloads to offboard for processing on respective selected IoT devices; and sending the workloads to the respective selected IoT devices.

An implementation of the method may further include determining that the task is offboardable based on the task being permitted to use asynchronous processing.

In another implementation, determining the selected IoT devices may include evaluating available shared resources of IoT devices within a threshold distance relative to the vehicle.

In a further implementation, determining the selected IoT devices may include evaluating qualities of service (QOS) of the plurality of IoT devices.

In an implementation, evaluating the QoS of the plurality of IoT devices may include filtering the plurality of IoT devices based upon network connection parameters of the plurality of IoT devices.

In another implementation, evaluating the QoS of the plurality of IoT devices may include filtering the plurality of IoT devices based upon an encryption compatibility of the plurality of IoT devices.

In a further implementation, evaluating the QoS of the plurality of IoT devices may include ordering the plurality of IoT devices based upon a best fit of available shared resources for the task and selecting a top number of the plurality of IoT devices as the selected IoT devices for offboarding of the task.

An implementation of the method may further include encoding the plurality of workloads into a plurality of respective containers, each container including code and dependencies for one of the workloads of the decomposed task.

In another implementation, sending the workloads to the respective selected IoT devices may include transmitting each of the plurality of containers to a respective one of the selected IoT devices.

Another implementation of the method may further include receiving and aggregating results data from the selected IoT devices for the workloads of the task to complete processing of the task.

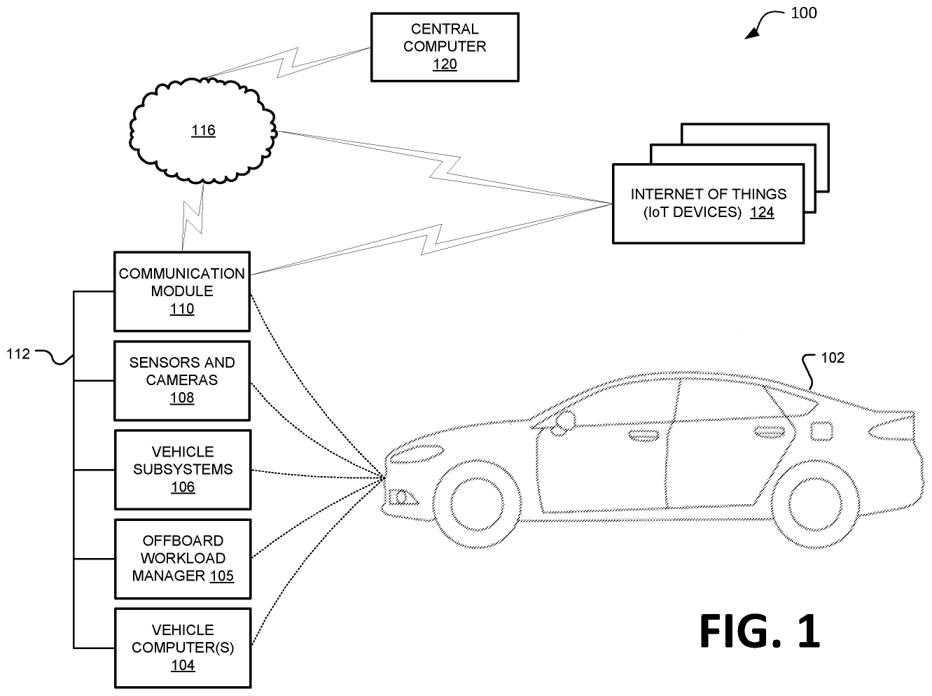

With reference to FIG. 1, a connected vehicle system 100 can provide communications between a vehicle 102, a central computer 120, and a plurality of IoT devices 124.

Vehicle 102 is a set of components or parts, including hardware components and typically also software and/or programming, to perform a function or set of operations in vehicle 102. Vehicle subsystems 106 typically include a braking system, a propulsion system, and a steering system as well as other subsystems including but not limited to an advanced driver assist system (ADAS) including various driver assist technology (DAT), a body control system, a climate control system, a lighting system, and a human-machine interface (HMI) system, which may include a heads-up display (HUD), an instrument panel, and infotainment system. The propulsion subsystem converts energy to rotation of vehicle 102 wheels to propel the vehicle 102 forward and/or backward. The braking subsystem can slow and/or stop vehicle 102 movement. The steering subsystem can control, e.g., turning left and right, maintaining a straight path, etc., of the vehicle 102 as it moves.

Computers, including the herein-discussed one or more vehicle computers 104, (e.g., one or more electronic control units (ECUs), and central computer 120 include respective processors and memories. A computer memory can include one or more forms of computer readable media, and stores instructions executable by a processor for performing various operations, including as disclosed herein. For example, the computer can be a generic computer with a processor and memory as described above and/or an ECU, controller, or the like for a specific function or set of functions, and/or a dedicated electronic circuit including an ASIC that is manufactured for a particular operation, e.g., an ASIC for processing sensor data and/or communicating the sensor data. In another example, computer may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in a computer.

A computer memory can be of any suitable type, e.g., EEPROM, EPROM, ROM, Flash, hard disk drives, solid state drives, servers, or any volatile or non-volatile media. The memory can store data, e.g., a memory of an ECU. The memory can be a separate device from the computer, and the computer can retrieve information stored in the memory, e.g., one or more computers 104 can obtain data to be stored via a vehicle network 112 in the vehicle 102, e.g., over an Ethernet bus, a CAN bus, a wireless network, etc. Alternatively, or additionally, the memory can be part of computer 104, i.e., as a memory of the computer 104 or firmware of a programmable chip.

The one or more vehicle computers 104 (e.g., one or more ECUs) can be included in a vehicle 102 that may be any suitable type of ground vehicle 102, e.g., a passenger or commercial automobile such as a sedan, a coupe, a truck, a sport utility, a crossover, a van, a minivan, etc. As part of a driver assist system or an advanced driver assist system (ADAS), a vehicle computer 104 may include programming to operate one or more of vehicle 102 brakes, propulsion (e.g., control of acceleration in the vehicle 102 by controlling one or more of an internal combustion engine (ICE), electric motor, hybrid ICE/electric propulsion, etc. and control power delivery therefrom), steering, climate control, interior and/or exterior lights, etc., as well as to determine whether and when the computer, as opposed to a human operator, is to control such operations, such as by sending vehicle data over the vehicle network 112. Additionally, a vehicle computer 104 may be programmed to determine whether and when a human operator is to control such operations.

Vehicle computer 104 may include or be communicatively coupled to, e.g., via a vehicle network 112 such as a communications bus as described further below, more than one processor, e.g., included in sensors and cameras 108, electronic controller units (ECUs) or the like included in the vehicle 102 for monitoring and/or controlling various vehicle components, e.g., a powertrain controller, a brake controller, a steering controller, etc. The computer is generally arranged for communications on a vehicle 102 communication network that can include a bus in the vehicle 102 such as a controller area network (CAN) or the like, and/or other wired and/or wireless mechanisms. Alternatively, or additionally, in cases where the computer actually includes a plurality of devices, the vehicle network 112 may be used for communications between devices represented as the computer in this disclosure.

Vehicle network 112 is a network via which messages can be exchanged between various devices in vehicle 102. The vehicle computer 104 can be generally programmed to send and/or receive, via vehicle network 112, messages to and/or from other devices in vehicle 102 e.g., any or all of ECUs, sensors, cameras, actuators, components, communications module, a human machine interface HMI, etc. Additionally, or alternatively, messages can be exchanged among various such other devices in vehicle 102 via a vehicle network 112. In cases in which the vehicle computer 104 includes a plurality of devices, vehicle network 112 may be used for communications between devices represented as a computer in this disclosure. In some implementations, vehicle network 112 can be a network in which messages are conveyed via a vehicle 102 communications bus. For example, vehicle network 112 can include a controller area network (CAN) in which messages are conveyed via a CAN bus, or a local interconnect network (LIN) in which messages are conveyed via a LIN bus. In some implementations, vehicle network 112 can include a network in which messages are conveyed using other wired communication technologies and/or wireless communication technologies e.g., Ethernet, Wi-Fi, Bluetooth, Ultra-Wide Band (UWB), etc. Additional examples of protocols that may be used for communications over vehicle network 112 in some implementations include, without limitation, Media Oriented System Transport (MOST), Time-Triggered Protocol TTP, and FlexRay. In some implementations, vehicle network 112 can represent a combination of multiple networks, possibly of different types, that support communications among devices in vehicle 102. For example, vehicle network 112 can include a CAN in which some devices in vehicle 102 communicate via a CAN bus, and a wired or wireless local area network in which some device in vehicle 102 communicate according to Ethernet or WI-FI communication protocols.

Vehicle computer 104 and/or central computer 120 can communicate via a wide area network 116. Further, various computing devices discussed herein may communicate with each other directly, e.g., via direct radio frequency communications according to protocols such as Bluetooth or the like. For example, vehicle 102 can include a communication module 110 to provide communications with devices and/or networks not included as part of the vehicle 102, such as a Global Positioning Satellite (GPS, not shown) and the wide area network 116, for example. Communication module 110 can provide various communications, e.g., vehicle to vehicle (V2V), vehicle-to-infrastructure or everything (V2X) or vehicle-to-everything including cellular communications (C-V2X) wireless communications cellular, dedicated short range communications (DSRC), etc., to another vehicle or infrastructure typically via direct radio frequency communications and/or typically via the wide area network 116, e.g., to the central computer 120. The communication module 110 could include one or more mechanisms by which a vehicle computer 104 may communicate, including any desired combination of wireless e.g., cellular, wireless, satellite, microwave and radio frequency communication mechanisms and any desired network topology or topologies when a plurality of communication mechanisms are utilized. Exemplary communications provided via the module can include cellular, Bluetooth, IEEE 802.11, DSRC, cellular V2X, CV2X, and the like.

A vehicle 102 in accordance with the present disclosure includes a plurality of sensors and cameras 108 that may support the driver assist or ADAS operations. For example, sensors and cameras 108 may include, but are not limited to, one or more wheel speed sensor, steering angle sensor, GPS sensor, forward-facing camera, side-facing camera, rear-facing camera, ultrasonic parking assist sensor, short range RADAR, medium range RADAR, light sensor, rain sensor, accelerometer, wheel torque sensors, inertial sensor, yaw rate sensor, etc.

A vehicle 102 in accordance with the present disclosure also includes an offboard workload manager 105 that may be used to offboard suitable compute and/or storage tasks (hereinafter, tasks). The offboard workload manager 105 is connected to the communication module 110 over the vehicle network 112 to exchange data with IoT devices 124 or central computer 120, such as via wide area network 116 or directly via V2V, V2X, Bluetooth, Wi-Fi, etc. The offboard workload manager 105 may include hardware components (i.e., processor and memory) and software and/or programming, to perform the operations discussed herein.

A central computer 120 may be connected to a database (not shown) and may provide data to offboard workload manager 105 about nearby IoT devices 124, i.e., within a specified distance of a location of vehicle 102. Alternately or additionally, offboard workload manager 105 may use communication module 110 to search for nearby IoT devices 124 within a specified distance of a location of vehicle 102 using standard techniques (i.e., based upon the IoT device 124 broadcasting its location and shared resources using V2V, V2X, Wi-Fi, Bluetooth, etc.).

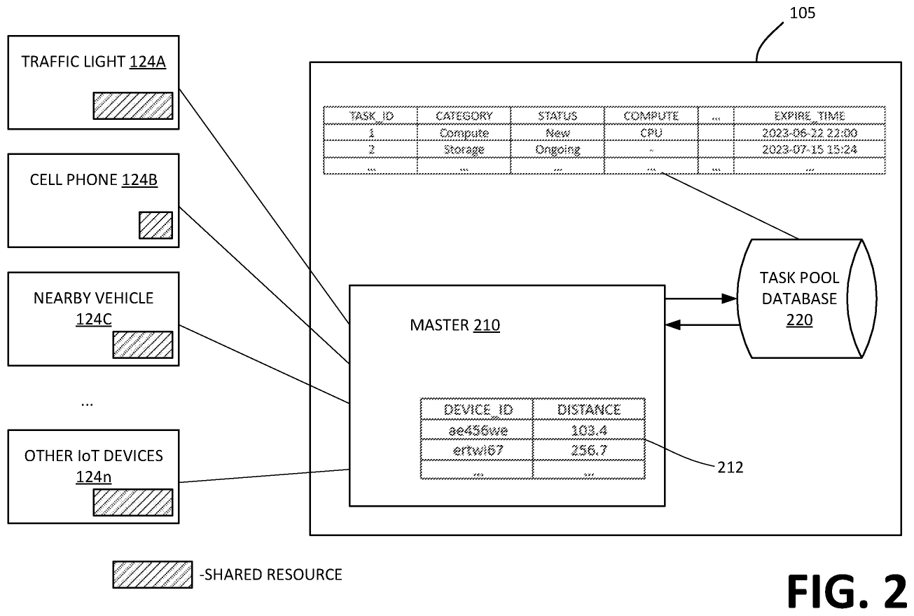

With reference to FIG. 2, an example schematic diagram of an offboard workload manager 105 for a vehicle 102 is illustrated.

Offboard workload manager 105 includes a master 210 which is a module including program instructions (in the form of software or a combination of hardware and software) to carry out various operations of the offboard workload manager 105.

As one operation, master 210 maintains a list or device map 212 of nearby IoT devices 124 that may include device identifiers (ID), a distance that the IoT device 124 is away from the vehicle 102, as well as other information, such as the available shared resources, access level, network connections, encryption compatibility, device constraints, device owner, etc. of each IoT device 124. Master 210 may maintain device map 212 by any suitable means. For example, master 210 may periodically download a list of nearby IoT devices 124A-124n from a database maintained by central computer 120 based upon a current location of vehicle 102. In another implementation, master 210 may maintain device map 212 by periodically scanning for communications from devices. In one variation, the searching algorithm may use a combination of Bluetooth Low Energy (BLE) and IPV6 meshing according to a conventional technique of discovering nearby IoT devices 124A-124n. Alternately or additionally, master 210 may use machine learning techniques to scan and then intelligently discover nearby IoT devices 124A-124n to which tasks can be sent. For example, a machine learning program such as a neural network could be trained with various device parameters, such as processing capacity (or an identifier for a processor), available memory, etc., and then a set of nearby devices could be deemed “discovered” based on output from the machine learning program. Discovered or identified devices could be limited according to a pre-defined distance (e.g., 1000 m) from the vehicle 102 to limit the number IoT devices 124A-124n in device map 212 to those within a specified proximity to vehicle 102. Alternately or additionally, scanning for devices could terminate upon reaching a pre-defined number of IoT devices 124 (e.g., 20) that are closest to the vehicle 102, which may vary based upon location, time of day, etc. In a further implementation, scanning can terminate the upon reaching a pre-determined amount of available resources.

IoT devices 124A-124n may include various types of devices, including infrastructure elements or edge devices such as traffic light 124A (i.e., a controller associated with a traffic light), mobile devices such as cell phone 124B, computers and/or ECUs in other vehicles such as nearby vehicle 124C, and/or other IoT devices 124n. Moreover, while referred to as Internet of Things devices, such IoT devices 124A-124n, as will be understood, generally include embedded sensors and computing devices that may be—but are not necessarily-connected to the Internet/World Wide Web and are at a minimum capable of joining a network using one or more standard protocols to exchange data. An IoT devices 124A-124n may include a fixed or variable amount of shared resources that it may report as available for use by other devices, including vehicle 102 and its offboard workload manager 105.

In one implementation, device map 212 may store a minimum amount of information to identify a specific IoT device 124, such as a device ID and a distance away from the vehicle 102, and additional information about the IoT device 124, such as shared resources, access level, network connections, encryption compatibility, device constraints, device owner, etc., may be offboarded and stored at central computer or in other IoT devices 124, such as in accordance with the offboarding principles of the present disclosure. Alternatively or additionally, device map 212 may store data sufficient to identify a specific IoT device 124, such as a device ID, a distance away from the vehicle 102, shared resources, and capabilities. Additional data about the IoT device 124, such as access level, network connections, encryption compatibility, device constraints, device owner, etc., may be offboarded and stored at central computer or in other IoT devices 124.

Offboard workload manager 105 includes a task pool that may be stored in a task pool database 220. As used herein, tasks comprise a computing and/or data storage workload that is requested by any one of various vehicle subsystems 106, and a task pool is a collection or set of tasks that need to be completed. The task pool database 220 may include, for respective tasks in a task pool, a task ID, a category (e.g., compute, storage, or both), a status (e.g., new, ongoing, processing, or completed), a type of compute (e.g., CPU, ASIC, etc.), an expiration time for the task, an assigned priority relative to other tasks, etc. In an implementation, task pool database 220 may contain both tasks that may be offboarded from the vehicle 102 and tasks that cannot be offboarded from the vehicle 102 based upon various operational or security constraints. In another implementation, the task pool database 220 may contain only tasks that may be offboarded from the vehicle 102.

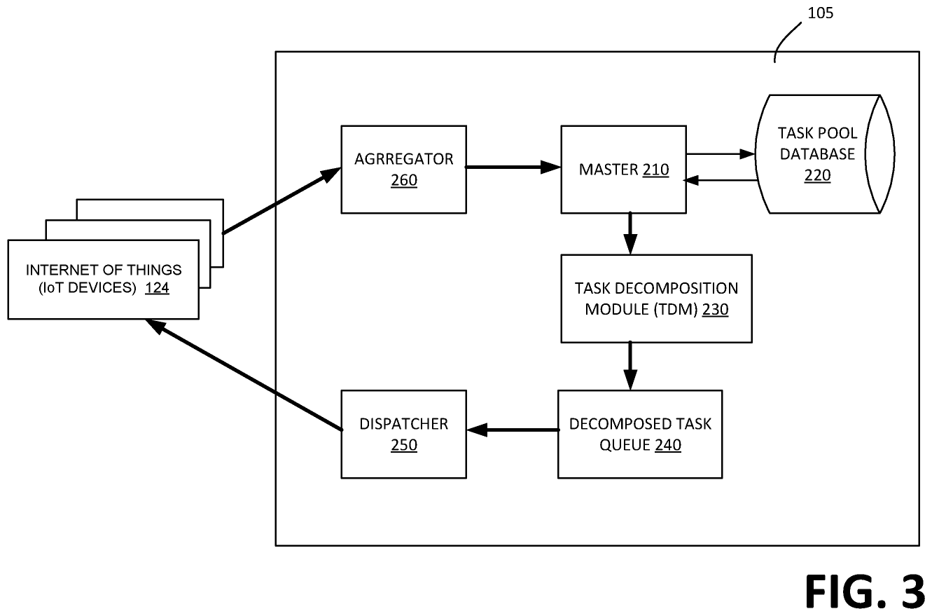

FIG. 3 illustrates an example flow diagram of an offboard workload manager 105 for vehicle 102. The arrows in FIG. 3 show possible transmission of data between devices. As with FIG. 2, the offboard workload manager 105 includes the previously described master 210 and task pool database 220. As indicated by an arrow, the master 210 may retrieve a task from the task pool database 220 that has a status of “to-do” or the like indicating that the workload of the task is ready to be worked on. As used herein, the overall workload of a task includes the computing components/requirements of the task and the storage components/requirements of the task, each of which may be subdivided into multiple parts as separate workloads. Additionally, as used herein, containers are packages of software that contain elements (code and dependencies such as runtime, libraries, etc.) to virtualize the operating system and run in any environment.

The offboard workload manager 105 further includes a task decomposition module (TDM) 230. The TDM 230 may be software or a combination of hardware and software that splits a task (i.e., decomposes the overall workload of a task according to any suitable technique, as is typically done for parallel or distributed computing operations) into multiple parts (i.e., decomposed workloads) and creates a plurality of containers that include the code and dependencies for performing each decomposed workload of the task. In an implementation, compute workloads may be split based upon elements required for one or more discrete calculations based upon a specific set of dependencies, and storage workloads may be split in any logical manner that maintains integrity of the data. TDM 230 may be controlled by, or a part of, master 210. The code and dependencies include information such as what is needed to process the workload and how to encrypt the results. As discussed further below, any suitable container, such as any Open Container Initiative (OCI) standard container, may be used, such as Docker or Podman containers. Upon the master 210 determining that a task may be offboarded, the master 210 sends the task to TDM 230 for the task to be split into multiple containers, and updates the status for the task in task pool database 220 as “processing” or the like indicating that the workload of the task is being acted upon. Since the TDM 230 splits the task into multiple containers, a compromise of security in a single IoT device 124 will not compromise the security of the task.

The offboard workload manager 105 also includes a decomposed task queue 240 in which the containers for a task are queued prior to being sent to a dispatcher 250. The decomposed task queue 240 may be accessed by master 210, e.g., may be stored in a short-term memory accessible by the master 210. The queued containers may be sorted based upon a priority within decomposed task queue 240. Priority may be assigned based upon the expiration time of the task, an assigned priority relative to other tasks, on a first-in first-out basis, or any other suitable manner. The decomposed task queue 240 may be software or a combination of hardware and software that performs its respective operations.

The offboard workload manager 105 further includes the dispatcher 250, which operates to transmit a next container from decomposed task queue 240 (i.e., dispatches to send the multiple containers of a task to corresponding multiple selected IoT devices 124 for execution of the code of the containers using the dependencies of the respective containers via the shared resources of the respective selected IoT devices 124. The dispatcher 250 may be software or a combination of hardware and software that perform its respective operations. In an implementation, the dispatcher 250 may work with master 210 or receive assignments for the selected IoT devices to determine compatible IoT devices 124 nearby with shared resources sufficient to perform each respective workload so as to determine which containers are dispatched to which IoT devices 124 among those selected, e.g., as shown in the process 600 discussed below. Dispatcher 250 may be controlled by or a part of master 210.

The multiple containers of a task are unpacked and executed at respective selected IoT devices 124 to perform the respective decomposed workloads associated with the task. Upon completion of each decomposed workload of a task at the respective selected IoT devices 124, the IoT devices 124 transmit the results data back to the offboard workload manager 105 where they are received by an aggregator 260. Aggregator 260 decrypts the results data received from the selected IoT devices 124 and aggregates the results that belong to the same task in an aggregated data set. The aggregated data are sent by the aggregator 260 to the master 210 where the master 210 may then further process the results, such as by providing the results over network 112 to the vehicle subsystem 106 that requested the task be performed or transmitting the results to central computer via communication module 110. The master 210 may also update the status for the task in the task pool database 220 as “completed” or the like so that the task may be subsequently deleted from the task pool database 220 if it is not a recurring task. Aggregator 260 may be controlled by or a part of master 210.

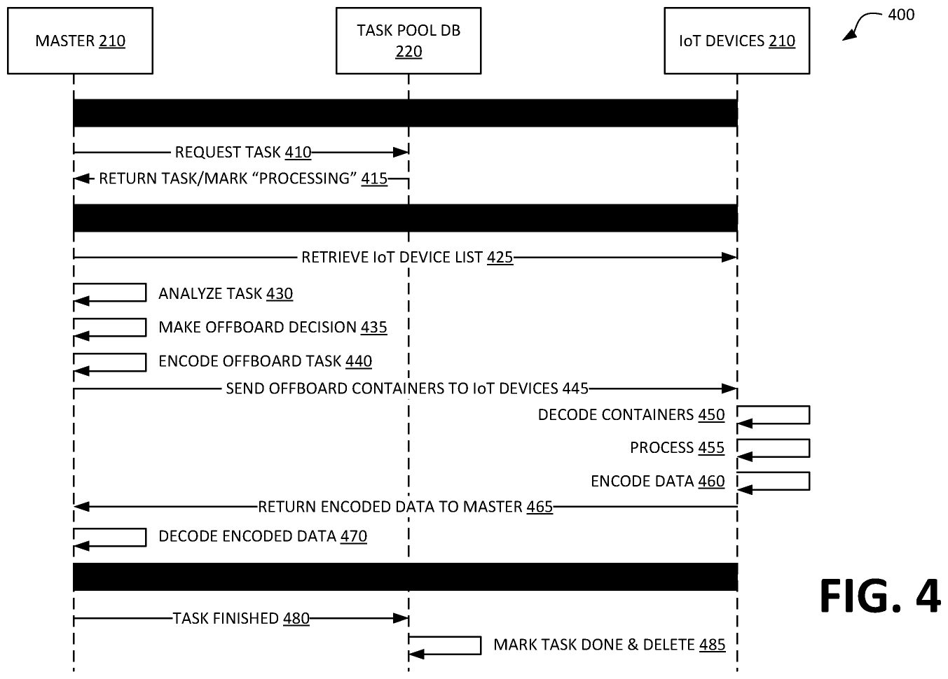

FIG. 4 illustrates an example operations diagram of an offboard workload management process 400.

In order to obtain a new task 405, master 210 may request task 410 via a message to task pool database 220. Task pool database 220 may return a task and mark the task as “processing” in the database at 415.

In order to offboard task processing 420 for a task, master 210 retrieves an IoT device list at 425. In this example, the master 210 may perform a searching algorithm with respect to nearby IoT devices 124 to create device map 212 having a list of IoT devices 124. In other examples, the master may retrieve an IoT list from a central computer 120 or may access additional stored details of device map 212 that have been previously offboarded to storage resources of IoT devices 124.

Master 210 analyzes the task at 430 in order to determine the task's time requirements (substantially real-time or asynchronous processing) and/or what compute and/or storage resources are needed to accomplish the task. Only tasks that may be processed asynchronously (i.e., at some point later in time based upon, for example, a set time when the task expires) may be offboarded. Other factors may also be considered, and some tasks may have restriction parameters indicating that they cannot be offboarded, such as due to data being processed being of a category or type deemed unsuitable for offboarding. The master 210 then makes an offboard decision at 435 when an asynchronous processing time requirement of the task and/or other factors allow it to be offboarded and the needed resources are available from nearby IoT devices 124. Tasks that have real-time processing requirements are not typically offboarded and are performed onboard the vehicle 102. Additionally, if needed resources for the task are not currently available from nearby IoT devices 124, even a task with asynchronous processing time requirements may not be offboarded at that time and may instead be processed onboard the vehicle 102.

After making the offboard decision at 435, master 210 encodes the offboard task at 440. Encoding the task at 440 may include splitting the workload of the task into a plurality of parts, and for each portion of workload, encoding a container with the code and dependencies to perform the portion of the workload. Any OCI standard container may be used, such as Docker or Podman containers, to encode the task into multiple containers for the multiple portions of the workload of the task. As noted in FIG. 3, TDM 230 may perform this operation and put the resulting containers in the decomposed task queue 240.

Master 210 then offboards the containers by sending them to selected IoT devices 124 at 445. As noted in FIG. 3, this may be performed by dispatcher 250 which may be included in or controlled by master 210 to determine compatible IoT devices 124 nearby with shared resources sufficient to perform each respective workload so as to determine which containers are dispatched to which IoT devices 124 among those selected in order to match shared resources with the workloads.

Selected IoT devices 124 receive the containers and decode the containers at 450 by performing any necessary decryption, and unpacking the code and dependencies within the container. Each IoT device 124 may then process its respective workload using the code and dependencies at 455 and encode data at 460 with the results data produced by the processing.

Typically, IoT devices 124 will have a primary operation, but may also have additional or extra resources that can be shared for processing of the offboarded workloads. These shared resources should be isolated from the main resources of the primary operation. As such, offboarded workloads should not have any access to non-shared resources of the IoT device 124. Data transmission to and from the IoT devices 124 can be encrypted, and IoT devices 124 may be able to decrypt received data and encrypt data before transmission to a workload manager 105. The shared resources of the IoT devices 124 may vary and include at least one of shared storage, shared memory, and shared compute capabilities. For example, a task may involve storage of data for later analysis, and thus may need shared memory resources. A computational task may need fast access to data and thus may need shared cache memory resources, or may need enough kernel available for workload execution and thus may need shared compute resources.

Upon encoding data at 460, the IoT devices 124 may encrypt the encoded data and return the encoded data to master 210 at 465. Master 210 decrypts and decodes the encoded data at 470. In accordance with FIG. 3, aggregator 260 may work with or under the control of master 210 to decrypt and decode the encoded data at 470 and aggregate the results that belong to the same task into an aggregated data set. The aggregated results data may be sent by the aggregator 260 to the master 210 where the master 210 may then further process the results data.

The offboard workload management process 400 may also operate to clean up the task pool at 475. In this process, master 210 indicates to the task pool database 220 that the task is finished at 480. The task pool database may then mark the task as done and delete the task from the task pool database 220 at 485.

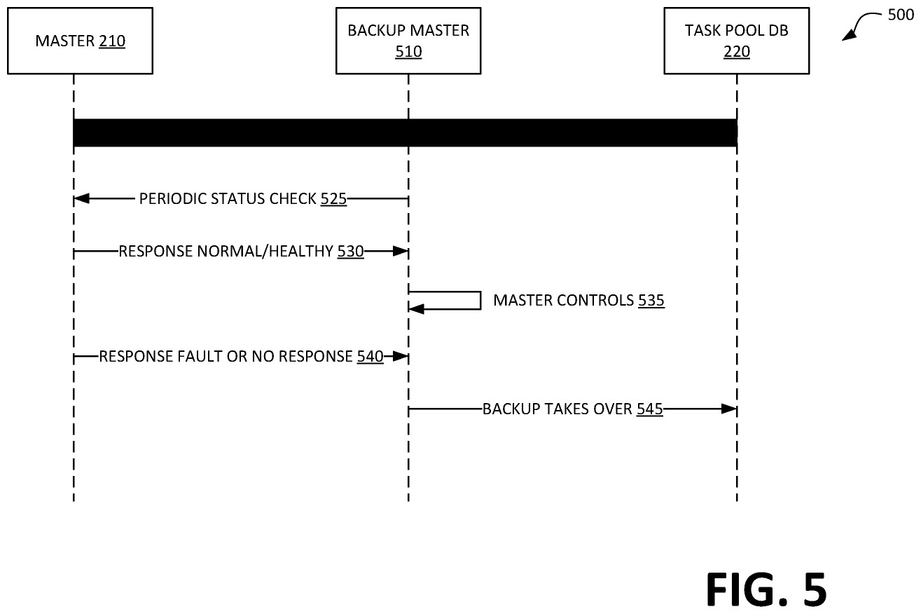

With respect to FIG. 5, an example operations diagram a process 500 for operating a backup master 510 is illustrated. A backup master 510 may be provided for purposes of redundancy.

A backup master mechanism 520 is initiated by the backup master 510, which has the same hardware and software as the master 210, requests a periodic status check 525 from the master 210. If the master 210 indicates to the backup master 510 that master 210 is responding normally or is healthy at 520, the backup master 510 determines that the master 210 controls operations at 535, and proceeds to wait for the next periodic status check 525. If the master 210 indicates to the backup master 510 that master 210 has a fault or if master 210 sends no response at 540, the backup master 510 may determine that the backup master 510 should take over at 545 and proceed with interoperating with the task pool database 220 in place of the master 210.

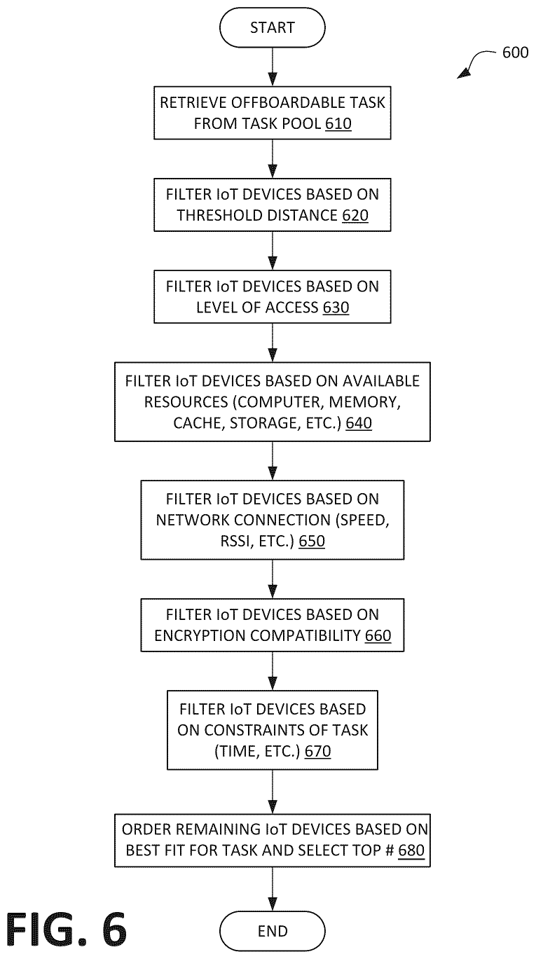

FIG. 6 illustrates an example flow diagram for a process 600 of evaluating and selecting Internet of Things (IoT) devices for offboarding of a task. IoT devices 124 performing the workloads of an offboarded task may be selected based upon their suitability for performing the workloads based upon their available resources and quality of service (QOS) as determined in the process 600, as now explained.

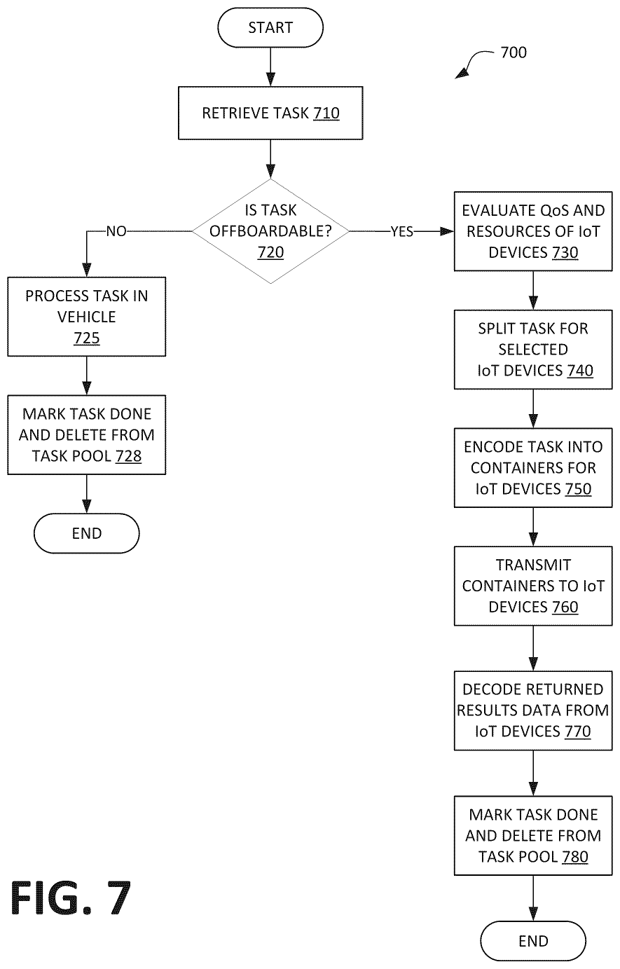

Accordingly, in a first block 610, master 210 retrieves an offboardable task from the task pool database 220. While this example assumes that the task is offboardable, in other implementations the master 210 may retrieve a task and determine whether the task may be offboarded from the vehicle 102. If not, the task can be routed for processing onboard using one or more computers 104 of the vehicle 102, as per FIG. 7 below.

Upon retrieving an offboardable task at block 610, master 210 may evaluate the resources needed for performing the workloads associated with the task which may be used for matching the workloads with suitable IoT devices 124.

In a next block 620, master 210 may access device map 212 and filter IoT devices 124 based upon a threshold distance from the vehicle 102. By using nearby IoT devices 124, the communication networks may be used efficiently, e.g., V2V and V2X communications and/or close-range networks or protocols, e.g., using Bluetooth or Wi-fi, may be used to reduce cellular network loads. Thus, transmitting and receiving data to and from nearby IoT devices 124, may be more efficient than transmitting data over multiple links to distant locations, using cellular communications that must then stay within a same cellular node, and/or utilize wide area network mechanisms that may be less efficient, e.g., because of limited bandwidth, limitations in transmission media, etc. Additionally, use of nearby IoT devices 124 may permit efficient utilization of computational and storage resources of the vehicle 102 for non-offboardable tasks.

In block 630, the nearby IoT devices 124 may be filtered based upon the level of access to the required resources within the shared resources of the nearby IoT devices 124. Accordingly, IoT devices that do not permit access to the resources (e.g., CPU, RAM, cache, storage, etc.) of the kind needed to perform the workload of a task may be eliminated from consideration.

In block 640, the nearby IoT devices 124 permitting access to the correct type of resources from block 630 are evaluated based upon the current availability of their shared resources (e.g., CPU, RAM, cache, storage, etc.). Since the workload of the task may be split between different IoT devices 124, the current availability of the resources may be used to decide how the task may be split and how many IoT devices 124 may be used in offboarding the task. For example, if a storage workload of a task requires 10 MB of storage, currently available devices having 3 MB of shared storage and 8 MB of shared storage may be used in offboarding the task, with the storage workload split into 2.5 MB and 7.5 MB respectively. In another example, a compute workload of a task may include a calculation requiring access to cached data and two other calculations that do not. Available devices may include one device with a CPU having a large cache and multiple devices having CPUs with small or no caches. In this case, the task may be offboarded to three devices by having the compute workload split such that the compute workload of the calculation requiring access to cached data is performed by the CPU of the one device with a large cache and the compute workloads of the other two calculations performed by respective CPUs of two of the other devices.

In a block 650, the IoT devices 124 may be filtered based upon the network connection, such as based on connection speed, connection signal strength, packet error rates, etc.

In a block 660, the IoT devices 124 may be filtered based whether the IoT devices are compatible with the encryption being used by the communication module 110 and/or the offboard workload manager 105.

In a block 670, the IoT devices 124 may be filtered based upon the constraints of the task, such as the time constraints in which the task must be completed, possible security constraints, etc.

Each of blocks 630, 640, 650, 660, and 670 may be performed in any suitable order and may be omitted or modified in particular situations. These blocks, in any combination, may be considered to constitute an evaluation and filtering of the IoT devices 124 based upon quality of service (QoS) and may further take into consideration transmission reliability, IoT device reliability, latency based upon request and response times after handshaking, and/or any other suitable metric that may affect the predictability or timeliness of transmitting or executing the offboarded workloads.

In a final block 670, suitable IoT devices 124 are ordered based upon a best fit determined according to any suitable technique for the multiple workloads of the particular task, resulting in an ordered list of suitable IoT devices 124 for the task. For example, in an implementation, a best fit may be accomplished by scoring multiple parameters such as resource availability, connectivity, preferred IoT device 124 and/or owner, distance, security capabilities of the IoT device 124, etc., and then ranking the IoT devices 124 based upon the scores. A number of IoT devices 124 sufficient to complete the workloads of the task in a timely manner may be selected from the ordered list of suitable IoT devices 124 for the task. The multiple containers for the task can then be transmitted to the selected IoT devices 124 for processing.

FIG. 7 illustrates an example flow diagram of a process 700 for offboarding a vehicle task to selected IoT devices or processing a task onboard the vehicle.

The process starts at a first block 710, wherein master 210 retrieves a task from the task pool database 220. If the task pool database 220 includes only offboardable tasks that do not need to be processed in real-time for operation of the vehicle 102, the process 700 may move to a block 730, discussed below. If the task pool database 220 includes both tasks that must be processed on board the vehicle 102, typically real-time tasks associated with current operation of the vehicle 102, as well as offboardable tasks that do not need to be processed in real-time for operation of the vehicle 102, the process 700 moves to a decision block 720.

In the decision block 720, a determination is made as to whether the task that was retrieved in the block 710 is an offboardable task from the category of tasks that do not need to be processed in real-time for operation of the vehicle 102 (e.g., tasks that may be processed asynchronously) and otherwise do not need to be processed within the vehicle 102 based upon restrictions, etc. Decision block 730 may also make an initial determination of whether nearby IoT devices have the resources needed to perform an otherwise offboardable task (e.g., blocks 620-640 of FIG. 6), and may determine that the task is not offboardable at the current time based on a lack of needed resources. If the task is not offboardable at block 720 (i.e., “NO”), the process 700 moves to a block 725.

In the block 725, the master 210 routes the task to be performed/processed onboard the vehicle on one or more of the computers 104, and then, upon completion of the task, to a block 728 wherein the master 210 operates to mark the task done and deletes the task from the task pool database 220.

If the task is offboardable at block 720 (“YES”), the process 700 moves to the block 730 wherein the master 210 evaluates the QoS and resources of the IoT devices 124 in accordance with the process 600 of FIG. 6 in order to select, from an ordered list of suitable IoT devices 124, a number of selected IoT devices 124 to perform the workload of the task.

In a next block 740, the master 210 or TDM 230 splits the task into multiple workloads for the correspondingly selected IoT devices 124. For example, if a task has compute and storage workloads, the compute workload may be split between multiple IoT devices 124 and the storage workload may be assigned to one or more of the same or different IoT devices 124 based upon the available shared resources available on the various IoT devices 124. In an implementation, the master 210 or TDM 230 may split the task into multiple workloads prior to selecting corresponding IoT devices.

After the task is split into multiple workloads at block 740, the master 210 or the TDM 230 may, in a block 750, encode the multiple workloads of the task into associated containers for the selected IoT devices 124, and may send the containers to the decomposed task queue 240 to be sent to the selected IoT devices 124.

In a next block 760, the master 210 or dispatcher 250 may transmit the multiple containers for the task to the selected IoT devices 124 for processing of the multiple workloads for the task.

In block 770, the master 210 or aggregator 260 decodes returned results data from the selected IoT devices and aggregates the data associated with the task to complete processing of the task by the master 210.

In block 280, the master 210 interacts with the task pool database 220 to mark the task as done and delete the task from the task pool database 220, after which the process 700 for the particular task ends.

While disclosed above with respect to certain implementations, various other implementations are possible without departing from the current disclosure.

Use of in response to, based on, and upon determining herein indicates a causal relationship, not merely a temporal relationship. Further, all terms used in the claims are intended to be given their plain and ordinary meanings as understood by those skilled in the art unless an explicit indication to the contrary is made herein. Use of the singular articles “a,” “the,” etc. should be read to recite one or more of the indicated elements unless a claim recites an explicit limitation to the contrary.

In the drawings, the same or like reference numbers indicate the same or like elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain implementations and should in no way be construed so as to limit the present disclosure.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A system comprising a vehicle computer of a vehicle including a processor and a memory, the memory storing instructions executable by the processor such that the computer is programmed to:
determine selected Internet of Things (IoT) devices from a plurality of IoT devices separate from the vehicle, wherein the selected IoT devices are selected based on being capable of performing a task including compute and/or storage for a vehicle subsystem;
decompose the task into a plurality of workloads to offboard for processing on respective selected IoT devices; and
send the workloads to the respective selected IoT devices.

2. The system of claim 1, further comprising instructions to:
determine that the task is offboardable based on the task being permitted to use asynchronous processing.

3. The system of claim 1, wherein the instructions to determine the selected IoT devices include instructions to evaluate available shared resources of IoT devices within a threshold distance relative to the vehicle.

4. The system of claim 1, wherein the instructions to determine the selected IoT devices include instructions to evaluate qualities of service (QOS) of the plurality of IoT devices.

5. The system of claim 4, wherein the instructions to evaluate the QoS of the plurality of IoT devices include instructions to filter the plurality of IoT devices based upon network connection parameters of the plurality of IoT devices.

6. The system of claim 4, wherein the instructions to evaluate the QoS of the plurality of IoT devices include instructions to filter the plurality of IoT devices based upon an encryption compatibility of the plurality of IoT devices.

7. The system of claim 4, wherein the instructions to evaluate the QoS of the plurality of IoT devices include instructions to order the plurality of IoT devices based upon a best fit of available shared resources for the task and select a top number of the plurality of IoT devices as the selected IoT devices for offboarding of the task.

8. The system of claim 1, further comprising instructions to encode the plurality of workloads into a plurality of respective containers, each container including code and dependencies for one of the workloads of the decomposed task.

9. The system of claim 8, wherein the instructions to send the workloads to the respective selected IoT devices include instructions to transmit each of the plurality of containers to a respective one of the selected IoT devices.

10. The system of claim 1, further comprising instructions to receive and aggregate results data from the selected IoT devices for the workloads of the task to complete processing of the task.

11. A method performed onboard a vehicle, comprising:
determining selected Internet of Things (IoT) devices from a plurality of IoT devices separate from the vehicle, wherein the selected IoT devices are selected based on being capable of performing a task including compute and/or storage for a vehicle subsystem;
decomposing the task into a plurality of workloads to offboard for processing on respective selected IoT devices; and
sending the workloads to the respective selected IoT devices.

12. The method of claim 11, further comprising:
determining that the task is offboardable based on the task being permitted to use asynchronous processing.

13. The method of claim 11, wherein determining the selected IoT devices includes evaluating available shared resources of IoT devices within a threshold distance relative to the vehicle.

14. The method of claim 11, wherein determining the selected IoT devices includes evaluating qualities of service (QOS) of the plurality of IoT devices.

15. The method of claim 14, wherein evaluating the QoS of the plurality of IoT devices includes filtering the plurality of IoT devices based upon network connection parameters of the plurality of IoT devices.

16. The method of claim 14, wherein evaluating the QoS of the plurality of IoT devices includes filtering the plurality of IoT devices based upon an encryption compatibility of the plurality of IoT devices.

17. The method of claim 14, wherein the evaluating the QoS of the plurality of IoT devices includes ordering the plurality of IoT devices based upon a best fit of available shared resources for the task and selecting a top number of the plurality of IoT devices as the selected IoT devices for offboarding of the task.

18. The method of claim 11, further comprising encoding the plurality of workloads into a plurality of respective containers, each container including code and dependencies for one of the workloads of the decomposed task.

19. The method of claim 18, wherein sending the workloads to the respective selected IoT devices includes transmitting each of the plurality of containers to a respective one of the selected IoT devices.

20. The method of claim 11, further comprising receiving and aggregating results data from the selected IoT devices for the workloads of the task to complete processing of the task.
